(19) United States
(12) Patent Application Publication
(10) Pub. No.: US 2026/0140280 A1
(43) Pub. Date: May 21, 2026

(54) SYSTEM AND METHODS FOR SENSING IMPACTS EXPERIENCED BY PHOTOVOLTAIC SYSTEMS DURING HAILSTORMS

(71) Applicant: AVSensor, LLC, Mont Vernon, NH (US)

(72) Inventors: Christopher Thomas Needham, Mountain View, HI (US); Frank Carl Oudheusden, Mont Vernon, NH (US)

(21) Appl. No.: 18/949,987

(22) Filed: Nov. 15, 2024

(51) Int. Cl. G01W 1/14; G01N 29/44; H02S 50/10

(52) U.S. Cl. CPC G01W 1/14; G01N 29/4418; G01N 29/4454; H02S 50/10

(57) ABSTRACT

Movement of photovoltaic panels is measured using an array of low-cost devices. Sensors are mounted on photovoltaic panels across a site to measure hail impacts. Time stamped data from the sensors is transmitted to a central computing device which, through an associated trained model, determines qualities of a hailstorm experienced by the site. Measured movement of the photovoltaic panels is used to determine when to place photovoltaic panels in a protective stow mode to reduce damage during a hail event.

### BACKGROUND

Solar photovoltaic (PV) systems are commonly affected by their environmental surroundings. The environmental conditions, such as hail, around a PV system can cause significant damage and cause the system to fail. PV system developers currently employ sensors to manage the operation of a solar power plant and to monitor damage to the PV system. Typically, these sensors are expensive and can interfere with the operation of PV panels due to shading or clearance requirements. To limit negative effects, a large PV power plant project may use only a few of each type of sensor to monitor the site.

Some projects use a small aluminum coated foam board that is permanently deformed by hail impacts as a method of recording what occurred during a hailstorm. Currently, no direct measurement of hail strike kinetic energy (KE) on PV modules is made on operational PV projects.

### BRIEF DESCRIPTION OF THE DRAWINGS

FIG. 1 illustrates a PV module with a sensor attached.

FIG. 2 is a detail view of a sensor on a PV module.

FIG. 3 illustrates a PV power project site with dedicated hail monitoring stations.

FIG. 4 illustrates a PV power project site with sensors.

FIG. 5 illustrates sensor communication with a central computing environment.

FIG. 6 illustrates a mesh network providing communication signals between sensors.

FIG. 7 illustrates a relationship between PV modules and sensors.

FIG. 8 is a flowchart illustrating a method for training a model to characterize hailstorms across a PV power plant.

FIG. 9 is a flowchart illustrating a method for determining hail impacts using a sensor.

FIG. 10 is a flowchart illustrating a method for determining when to stow PV modules.

FIG. 11 is a block diagram illustrating an example ML system.

FIG. 12 illustrates an exemplary computing environment.

### DETAILED DESCRIPTION

The present disclosure describes a distributed array of sensors used to monitor the volume and distribution of hail impacts on the surface of PV modules throughout a project site through measurement of the KE of hail strikes. Each sensor is installed as associated with a PV module and measures the vibratory response of the module under hail impacts directly. The use of multiple PV modules in this fashion provides a much larger surface area for sensing hail than current methods. This approach also more accurately captures the full distribution of hail that occurs on a site during a hailstorm when compared to the current methods in use. A PV module includes a PV panel and in some embodiments the PV panel system superstructure supporting the PV panel. The PV panel system superstructure includes PV panel framing and PV panel mounting accessories. A single PV module has one or more sensors installed to categorize the impact energy of a hail strike.

In some embodiments, these sensors are installed directly on the backside of the PV laminate. In other embodiments, these sensors are installed on the module frame or tracking structure. The disclosed technology can use a variety of sensor types to measure the KE of hail strikes. Example sensor types include, but are not limited to, six-axis accelerometers, three-axis accelerometers, three-axis gyroscopes, inclinometers, vibrometers, strain gauges, decibel meters, and force sensors. Using the disclosed array of sensors to monitor hail loads across a PV system is crucial in identifying liability after a hailstorm event. Additionally, such monitoring can in inform the industry as to the best hail stow practices to reduce PV system failures.

Due to a lack of direct measurement of hail strike kinetic energy KE on PV modules today, insurance claims are simply based on the largest hail ball sizes identified by the sampling devices. However, with few sampling locations, PV power plants face an inadequate understanding of the distribution of hail ball size and hail kinetic energy that impacts the module surfaces. Such an inadequate understanding leads to inaccurately identifying liability after a hailstorm event. Additionally, using a low number of sample locations leads to poor PV plant design. For example, the resulting inadequate understanding of the distribution of hail kinetic energy that impacts the module surfaces misinforms the solar industry as to the best hail stow practices to reduce failures, leading to improper storage tactics and more PV power plant damage. Further examples of poor PV plant design resulting from this lack of understanding include, but are not limited to, incorrect hail impact modeling or analysis, insufficient front-glass panel thickness, faulty impact sensor equipment, and PV plant power losses. The result of these issues is evident within the industry with the increasingly common insurance losses on several large PV systems.

In the disclosed technology, a model is trained to identify qualities of a hailstorm across a PV system based on impact data from the aforementioned sensors associated with the PV system. To train the model, locations of a PV module are selected to mount the sensor(s). Then, the PV module with sensor(s) installed is impacted with hail balls of a known size, KE, incidence angle, frequency, and location on the panel. Training data is supervised or collected in known conditions. Additionally, attributes of the PV module are recorded. The PV module attribute data pertains to characteristics of the power plant including, but not limited to, sensor location on the PV module, PV module tilt angle during hail impacts, PV module stow angle, PV module glass thickness, PV module tracking system damping, PV module tracking system deflection, PV module structure thickness, PV module superstructure construction, PV power plant site topography, and the wind velocity. Next, other combinations of hail ball impacts are made according to a design of experiments that vary hail size, KE, incidence angle, frequency, location, and PV module attributes over a range of values and attributes that are anticipated for a relevant project. Finally, a trained model is formed by fitting a characterization function to the training data set. The characterization function is the formula ultimately used by the trained model to determine predicted data based on observed data.

In the disclosed technology, the trained model receives sensor data and PV module attribute data of the site at the time of a hail event. The sensor data received by the trained model is the KE of hail strikes on the PV modules and the timestamps thereof. The model is trained to characterize the received sensor and PV module attribute data during a hailstorm. This characterization determines qualities of the hailstorm including, but not limited to, hail size, hail impact force, hail impact KE, hail impact location, hail impact frequency, hail impact incidence angle, hailstorm duration, location of PV module failure, the time of PV module failure, and the attributes of the PV module. The hailstorm qualities resulting from the characterization process gives project owners and insurers an understanding of a hailstorm experienced by a PV system at a level far more granular than is available today.

In some embodiments, the trained model characterizes a hail event in real-time throughout a hail event. In another embodiment, sensors act as a black box, whose data is retrieved and entered into the trained model for characterization of a hail event after the hail event occurs (e.g. the sensor data is downloaded onto a USB drive used to upload the data to a computer that hosts the trained model). Characterizing hailstorm data after a hail event allows low cost and rapid installation of hail sensors on a given project as characterization may be financially justified only after a hail event. In some embodiments, the sensors operate as standalone units that sense hail impacts, compute the qualities of the hailstorm experienced by a corresponding PV module, and store the result. In some embodiments, these standalone units store the result to be manually retrieved from each unit after a hail event. In other embodiments, these standalone units communicate in a mesh or within a central computing environment.

In some embodiments, the characterization process identifies when a PV module fails from hail impacts by monitoring when the panel response to hail impacts changes, representing a failed PV module laminate, and time stamping this event. In another embodiment, the disclosed technology collects the data related to PV module failures. Collecting such data provides the PV industry with statistically valid information regarding PV module breakage rates that is not currently available.

In some embodiments, the trained model generates a visual representation of the hailstorm qualities based on observed data from a hailstorm. For example, the trained model can generate a histogram showing the total KE of all hail impacts, the highest KE of a single impact, or other appropriate statistical representations. In another example, the trained model sends the hailstorm qualities to a display device with instructions to display a map of the hailstorm and its qualities.

The disclosed technology is compatible with a broad variety of PV systems including fixed-tilt systems, single-axis tracker systems, flexible single-axis tracker systems, and multi-axis tracking systems. In some embodiments, the trained model applies regardless of PV system type. For example, a model trained on a particular PV module type across a range of PV module tilt angles can return accurate data for a given PV module of the same type regardless of whether the given PV module is installed in a fixed-tilt system or a single-axis tracker system. In other embodiments, the model is trained to characterize a hail event for a particular type of PV system. For example, a model trained to characterize a hail event experienced by a fixed-tilt system for a particular PV module tilt angle may not be adequately trained to characterize a hail event experienced by a flexible single-axis tracker system.

In some embodiments of the disclosed technology, a computing system determines whether all PV modules, or individual PV modules, within a PV power plant should be placed in a hail stow position to decrease the likelihood of damage from the hail event. The computing system sends a signal to a tracking system of a PV power plant to adjust PV module tilt based on the hailstorm characterization. PV power systems frequently track the sun to various degrees to increase the amount of energy produced by the system. These trackers typically move photovoltaic modules to adjust an angle of incidence of the sunlight on the surface of the PV modules. In particular, trackers typically rotate the PV modules around an axis principally oriented north to south, tilting the modules to as much as 60 degrees towards the east and west and adjusting tilt within this range throughout the day.

By tracking the position of the sun, PV power systems often produce 20-30% more energy than fixed-tilt systems (i.e. systems with no tracking capabilities). A common configuration of horizontal single-axis trackers (“SAT”) as described above includes a single actuator near the center of a row of PV modules, potentially with 80-120 modules tilted by a single actuator. The angle of tilt is defined by the position of the actuator, while a torque tube or other similar device transfers moments and positions the rest of the row at the tilt of the actuator. However, environmental loading (wind, snow, dead load, etc.) can twist portions of a row away from the intended tilt angle. These types of solar trackers are referred to as “flexible” within the industry in comparison to types that use an actuator on sufficient points along a solar tracker row to constrain maximum twist to less than 10 degrees delta measured along a given row.

Flexible PV systems generally rely on as few actuators as possible (actuators are comparatively expensive parts). The ratio of actuators to panels is higher than in non-flexible systems. Non-flexible tracking systems use more actuators in place of damping; however, the additional actuators increase the overall cost of the system.

For purposes of this disclosure a “flexible” solar tracker system is one subject to sufficient deflection as to require aeroelastic consideration. 10 degrees of absolute twist is a typical cut-off for when a static wind tunnel test report may be used without specific aeroelastic testing added in. However, the selection of 10 degrees of absolute twist is subjective on the part of the wind tunnel test facilities and allows for a buffer between when aeroelastic effects begin to dominate. Flexible tracker systems allow for deflection requiring aeroelastic consideration due to a relative lack of points of fixity along each row. Actuators generally act as points of fixity. Rows that have few (or a single) actuator or other point of fixity per panel/module are flexible.

Solar tracker systems can be significantly damaged by hail events. However, these systems can reduce damage from hail events by tilting the panels away from harm. As such, in one embodiment, the disclosed technology sends a signal to an actuator of a PV module to tilt away from the hail as determined by the hailstorm characterization. For example, in a windless hail event occurring above a flat PV power plant, the disclosed technology can signal the tracking system to orient the panels perpendicularly to the flat ground (i.e. a high tilt stow).

In some embodiments, the tracking system, in response to information determined by the trained model, sends a signal to individual actuators for individual rows of PV modules and/or individual actuators for individual PV modules to adjust the corresponding PV module tilt. The ability to tilt panels and rows individually allows the disclosed technology to maximize damage reduction during a hailstorm. For example, some hailstorms can have differences in the direction the hail is dropping over a large-scale PV power plant. As such, a PV module tilt angle that reduces the most damage on one side of the large-scale PV power plant may not be the best angle to reduce the most damage on another side. Additionally, PV power plant sites can have varying topography, which can alter the exposure individual PV modules in the site have to hailstorms. The ability to tilt panels and rows individually, therefore, allows the disclosed technology to respond to hailstorm and topography variation across PV power plant sites.

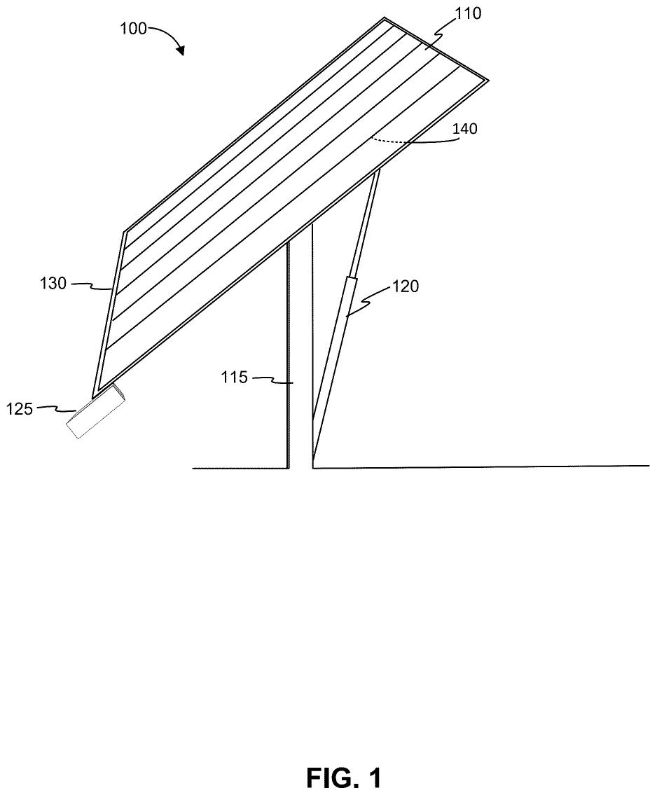

FIG. 1 illustrates one embodiment 100 of a sensor 125 mounted on a PV module 110. The PV module 110 is supported by a base 115. The angle of tilt of the PV module 110 is adjusted by an actuator 120 that is coupled to the base 115 and the PV module 110. The sensor 125 is mounted on an edge 130 of the PV module 110. The sensor 125 is mounted on the edge 130 so that an additional small PV module that is part of the sensor and powers the sensor 125 is exposed to the sunlight. In some embodiments, the sensor 125 is mounted on the backside 140 of the PV module 110. In another embodiment, multiple sensors 125 are mounted across the backside 140 and the edge 130 of PV module 110. Mounting the sensor across the backside 140 and the edge 130 of PV module 110 is advantageous because the PV module 110 experiences different impact forces at the edge 130 than at points next to the base 115. Thus, with multiple sensors on one PV module, the trained model can replicate its characterization process for each sensor and employ statistical methods to further refine its characterization of the hailstorm experienced by said PV module.

In the disclosed technology, sensor 125 can take a variety of forms to measure the hailstorm impact data. In one embodiment, sensor 125 is a six-axis accelerometer. A 6-axis accelerometer measures both linear acceleration and rotational velocity along three perpendicular axes (X, Y, and Z), providing comprehensive motion data. It integrates a 3-axis accelerometer with a 3-axis gyroscope, enabling precise tracking of an object's movement and orientation. In another embodiment, sensor 125 is a three-axis accelerometer. A 3-axis accelerometer measures linear acceleration along three perpendicular axes: X, Y, and Z and it detects changes in velocity and orientation. In another embodiment, sensor 125 is a 3-axis gyroscope. A 3-axis gyroscope measures rotational velocity around three perpendicular axes: X, Y, and Z and it provides precise data on angular motion, enabling accurate tracking of an object's orientation and rotation.

In another embodiment, sensor 125 is an inclinometer. An inclinometer measures the angle of tilt or slope relative to gravity along one or more axes. It provides precise data on the inclination or orientation of an object. In another embodiment, sensor 125 is a vibrometer. A vibrometer measures the velocity, displacement, and acceleration of vibrations in an object. It provides precise data on the frequency and amplitude of vibrations. In another embodiment, sensor 125 is a strain gauge. A strain gauge measures the amount of deformation or strain in an object when subjected to external forces. It provides precise data on the change in electrical resistance as the object deforms, which correlates to the amount of strain experienced. In another embodiment, sensor 125 is a decibel meter. A decibel meter measures the intensity of sound in decibels (dB), quantifying the loudness of noise in an environment. In another embodiment, sensor 125 is a force sensor. A force sensor measures the magnitude of force applied to an object and provides precise data on the amount and direction of force.

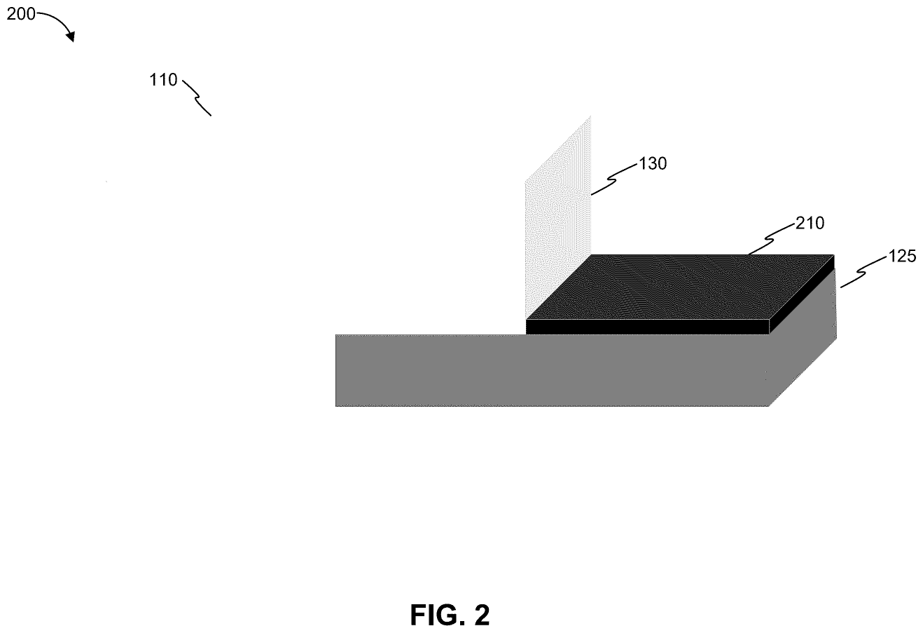

FIG. 2 illustrates an orthogonal view 200 of the sensor 125 on the PV module 110. The sensor 125 is installed on the bottom of the PV module 110, so that the sensor 125 does not shade the PV module 110. A portion of the sensor 125 extends beyond the edge 130 of the PV module 110. A small sensor PV panel 210 is mounted on the upper side of the sensor 125. The sensor PV panel 210 is oriented in the same direction as the PV module 110, so that the sensor PV panel 210 collects sunlight at the same time as the PV module 110. The sensor PV panel 210 powers the sensor 125. The sensor PV panel 210 collects energy independently of the PV module 110 itself. Using an independent sensor PV panel 210 allows the sensor 125 to operate independently of the PV panel 210 power system.

Sensor 125 may also include a wi-fi repeater and a battery. The wi-fi repeater creating a mesh network on the site with other sensors 125 with wi-fi repeaters. The battery is capable of being charged by the sensor PV panel and providing power to the sensor and wi-fi repeater during nighttime and low light conditions. The sensor includes a power module. The power module providing maximum power point tracking, battery charging/discharging and regulated power supply for an IOT platform.

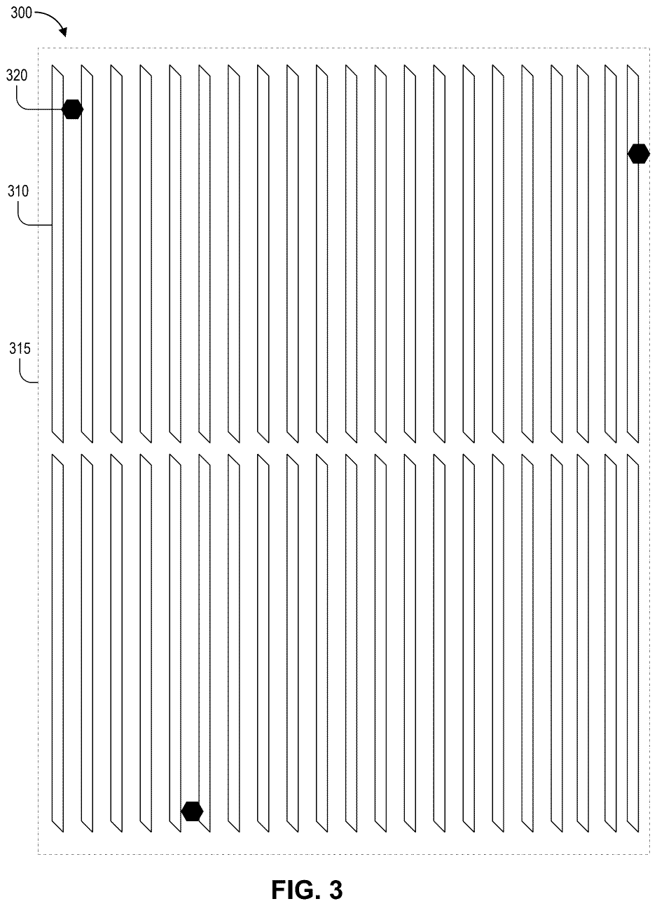

FIG. 3 illustrates an example of placement of dedicated hail monitoring stations 320 on the PV power plant site 300. Here three dedicated hail monitoring stations 320 are shown along the edges of the PV power plant site 300. The dedicated hail monitoring stations 320 are distributed among the PV systems 310 in the array. The PV power plant site 300 is bounded by a property boundary 315. Based on common practice, many PV power plant sites only have one dedicated hail monitoring stations 320 due to their expense and other limiting factors like shading on PV module surfaces.

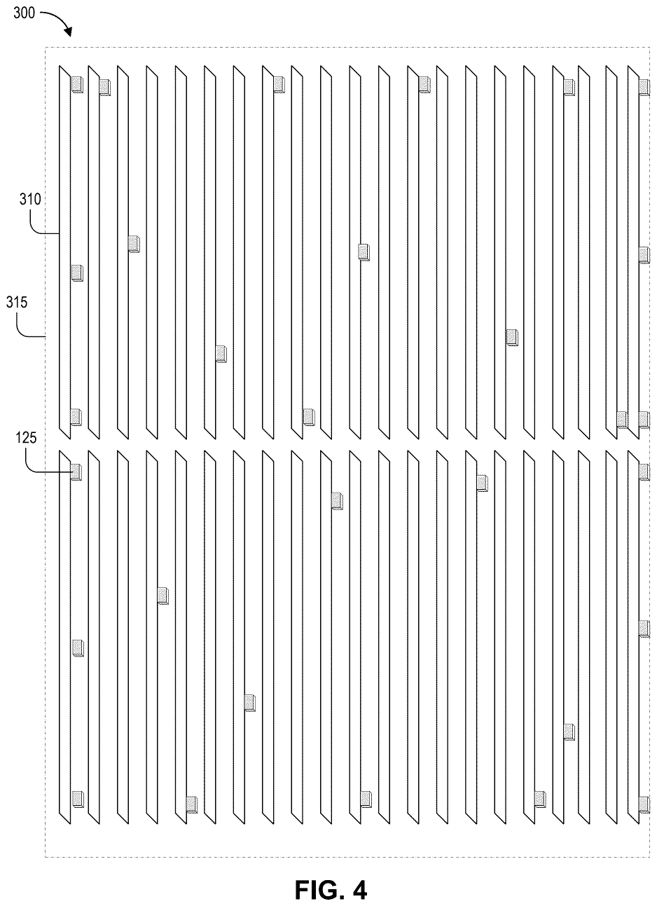

FIG. 4 illustrates example placement of sensors 125 on the same PV power plant site 300. The sensors 125 are distributed across the PV power plant site 300. The number of sensors 125 is significantly greater than the number of dedicated hail monitoring stations 320 in FIG. 3. In some embodiments, sensors 125 are evenly distributed across the PV power plant site 300. In another embodiment, sensors 125 are placed sporadically across the PV power plant site 300 and shown in FIG. 4. Each monitored PV module measures a larger surface area than the typical hail sensor plate, increasing the accuracy of characterizing the distribution and frequency of hail impacts on the site. The low-cost nature of measuring the hail impacts on site by using the PV module response directly, as compared to dedicated hail monitoring stations, allows a project owner to measure hail strikes at more locations throughout the array, further increasing measurement accuracy.

Site topography may be such that different portions of the PV power plant site 300 are more likely to experience higher hail impact loads. For example, the center of the PV power plant site 300 may be at the top of a hill and the edges of the PV power plant site 300 may be located down in a valley that are partially shielded from a hailstorm by the hill. An increased number of sensors 125 may be placed at the top of the hill to more accurately measure the hailstorm. Fewer sensors 125 may be placed at the lower elevations because the hailstorm may be less intense at the lower elevation.

Sensors 125 can be placed at many locations across the PV power plant site 300 no matter the expected hail risk at each location because the PV modules 110 may move into a stowed position at different times depending on the hailstorm experienced at that particular location.

Saturation of sensors 125 varies from power plant site 300 to site 300. Once a predetermined density threshold of sensors 125 is met, there are diminishing returns on the addition of additional sensors 125. In this case, sensor density takes into account sensors per row, as well as sensors per row edge, sensors per row center, sensors per site edge, sensors per site center, and sensors per PV module.

An upper tolerance for vibration in the PV modules 110 can be preset. Then when a specific panel reaches the upper limit of acceptable vibration the PV module 110 is moved into a stow position to reduce damage to the PV module 110. The stow position is a safer position for the PV module 110 that reduces damage to the PV module 110.

PV modules 110 can be moved to a stow position with more accuracy and granularity because of the number of sensors 125. When sensor 125 detects vibration indicating that the PV module 110 will be damaged, the PV modules 110 in the immediate vicinity of the sensor 125 are stowed. If other sensors 125 are not observing such large vibrations, then the PV modules 110 in the vicinity of those sensors 125 can be left in the operating position and continue to collect the maximum amount of sunlight. The additional data and ability to measure movement of many different PV modules 110 allows the system to stow with greater accuracy. The system can stow vulnerable tracker units and leave more shielded tracker units in position thus increasing their operating time.

Another benefit of directly measuring the vibrations of the PV module 110 is that project owners and insurance providers understand more about the conditions around the PV module 110 before failure. Data from sensors 125 and other sensors is recorded as it is collected and then referenced after the failure. This data could show whether or not there was unintentional movement of the PV module 110, if the PV module 110 was responding in a manner not consistent with its design, if there were large hail ball sizes, high impact forces, or other unusual conditions prior to failure.

In addition to sensors 125, the site may include additional sensors to observe environmental conditions surrounding the PV system and to improve PV system performance. Additional sensors may include but are not limited to a snow detection sensor such as an ultrasonic or laser sensor. Snow detection sensors reduce the risk of trackers moving into an unknown snowbank, the snowbank reducing sunlight collection or damaging the tracker. The snowbank having been created by a snow drift on the site. A stress/strain sensor for determining the structural load induced on the structural members. On site security cameras providing remote visual access to the site for monitoring the site from one or more points of view. An irradiance sensor for measuring the rate at which solar energy falls onto a surface. A soiling measurement sensor for measuring the soiling effects on the PV modules and determining the amount of soiling versus a determined non-soiled baseline. A humidity sensor for measuring the humidity in the ambient air. A temperature sensor or thermometer for measuring the ambient air temperature.

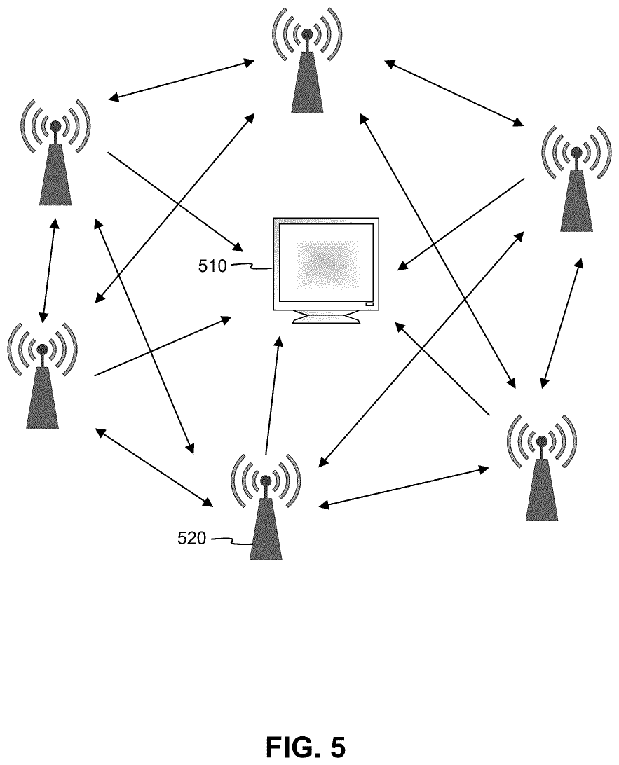

FIG. 5 illustrates sensors 520 (sensors including accelerometers, gyroscopes, inclinometers, vibrometers, snow detection sensors, stress/strain sensors, on site security cameras, irradiance sensors, soiling measurement sensors, humidity sensors, temperature sensors and any other sensor that observes on site environmental conditions or improves PV panel function) communicating with a central computing system 510. Each sensor 520 is enabled to transmit a signal, either through a wired or a wireless connection. The signal transmitted consists of the sensor data and data obtained from any other sensing devices that is included within the sensor apparatus 520. The central computing system 510 is located on or off site so that the central computing system 510 can receive data transmissions from the sensors 520 at all times. Using a central computing system 510, conclusions about environmental conditions can be drawn from the collected sensor 520 data. The data can be correlated across multiple sensors 520. The multiple sensors 520, when taken together, can show qualities of the hailstorm. For example, the sensors 520 can show which sensor records KE impact data during a specific time period.

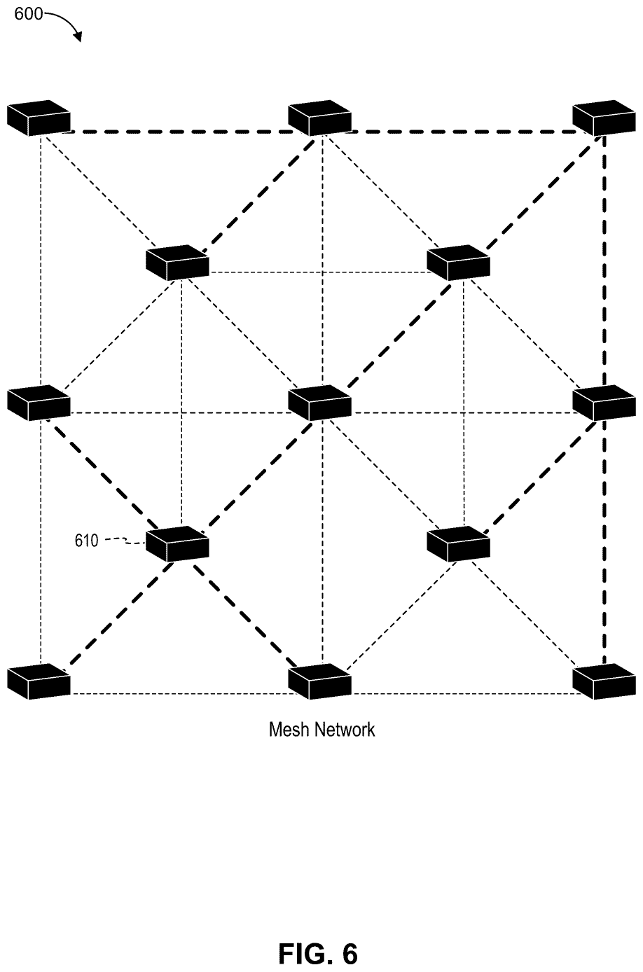

In some embodiments, a computing environment occurs on each sensor 520. Such a computing environment allows each sensor 520 to operate as standalone units for sensing vibrations caused by a hail event, computing the qualities of the hail event on the sensor directly, and storing the results onboard each sensor 520. In some embodiments, the results stored onboard each sensor 520 are manually pulled to analyze the hail event (e.g. the results from each sensor 520 are downloaded onto a USB drive, which is then plugged into the central computing system 510). In other embodiments, each sensor 520 operating as a standalone unit communicates with a central computing system 510 to retrieve the results stored onboard each sensor 520 and draw conclusions about the hail event. In some embodiments, sensors 520 operating as standalone units communicate with each other using a mesh network as describe in FIG. 6.

FIG. 6 illustrates a mesh network 600 established by the sensors 610. According to one embodiment, each sensor 610 has a wi-fi repeater device. The sensors 610 are laid out in a mesh to improve data collection. According to one embodiment, the mesh network 600 is a distributed network with no central node. Each node connects to neighboring nodes. The nodes are mutually responsible for transferring the data of the other nodes. The nodes operate as network access points within the mesh network. According to another embodiment the mesh network 600 is divided into regions of nearby sensors 610. Each mesh region is a distributed network with no central node and each node connects to neighboring nodes in the region. These nodes are mutually responsible for transferring the data of the other nodes within the region and they operate as network access points within the mesh region network.

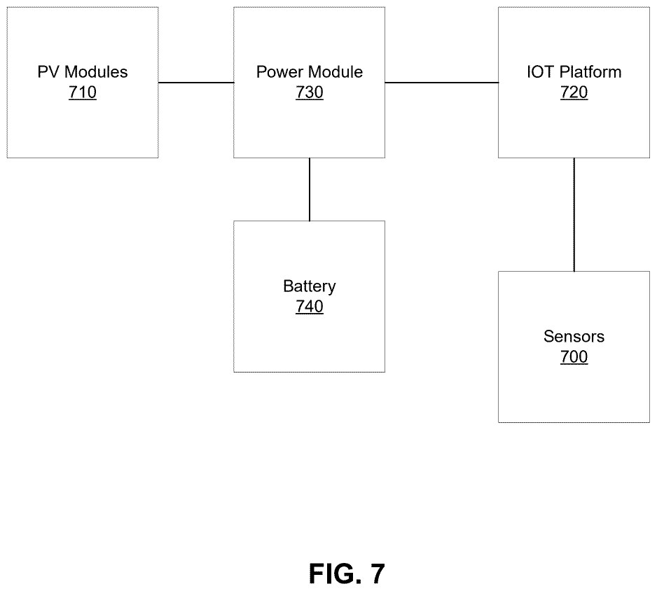

FIG. 7 illustrates a relationship between the sensors 700 and the PV modules 710. In some embodiments, the sensors 700 communicate with an IOT Platform 720. The IOT Platform 720 determines what actions the PV modules 710 should take and then communicates that information to the PV modules 710 through the Power Module 730. The Power Module 730 is powered by a battery 740.

In some embodiments, sensors 700 all connect to a server associated with the IOT Platform 720. Each sensor sends data to the server for storage and further action. In other embodiments, sensors 700 are connected as a mesh network and one sensor in the mesh is connected to a server associated with the IOT Platform 720. The sensors 700 send data through the sensor connected to the server for storage and further action. In some embodiments, sensors 700 are connected as a mesh network and multiple sensors in the mesh are connected to a server associated with the IOT Platform 720. The sensors 700 send data through the multiple sensors connected to the server for storage and further action.

In some embodiments, the server associated with the IOT Platform 720 sends the sensor data to a trained model through a Model API associated with the IOT Platform 720. An API is a set of rules and protocols for building and interacting with software applications. It defines the methods and data formats that applications can use to communicate with each other. In the disclosed technology, the Model API is a set of rules and protocols configured to communicate the sensor data stored on the server to the trained model. Then, the trained model uses the sensor data to return predicted data of the event experienced by the sensors (e.g. the hail ball was 1 inch in diameter) to the IOT Platform 720 and the server associated with the IOT Platform 720. In some embodiments, the trained model is stored on the server associated with the IOT Platform 720. In other embodiments, the trained model is stored externally to the server and the IOT Platform 720.

In some embodiments, the IOT Platform 720 uses the predicted data from the trained model to determine what actions the PV modules 710 should take. The IOT Platform 720 then communicates said actions to the PV modules 710 through the Power Module 730. The Power Module 730 is powered by a battery 740.

In some embodiments, the sensors 700 are connected via mesh regions that correspond to regions of the PV modules 710 in a PV power system. The IOT Platform 720 includes servers for each mesh region. Each sensor mesh region is connected to its own region server associated with the IOT Platform 720. The sensors 700 send data through the mesh regions to the associated server. Said server sends the sensor data to a trained model through a Model API associated with the IOT Platform 720. Then, the trained model returns predicted data of the event experienced by each mesh region to the IOT Platform 720. The IOT Platform 720 determines what actions the PV modules 710 of each region should take and communicates said actions to the PV modules 710 through the Power Module 730. The Power Module 730 is powered by a battery 740.

Data collected by the sensors 700 and other sensors associated with the PV modules 710 can be used to predict when the PV modules should be stowed. For example, an artificial intelligence computer model can model PV module behavior under different hail impact loads and hail incidence angles to predict at which hail impact loads and hail incidence angles the PV modules should be stowed to avoid damage. Said artificial intelligence computer model can also predict when the PV modules should be left in the operating state despite environmental conditions to continue to collect solar energy. The PV system can either be in a full operating state where energy yield is maximized or a reduced operating state where there is a balance between impact damage mitigation and energy production. Similarly, the data analyzed can be used to predict the cause of a failure after it has occurred. The data may indicate that the failure occurred because the installation was malfunctioning prior to the hail event or because at a certain hail size or impact force, the PV system failed.

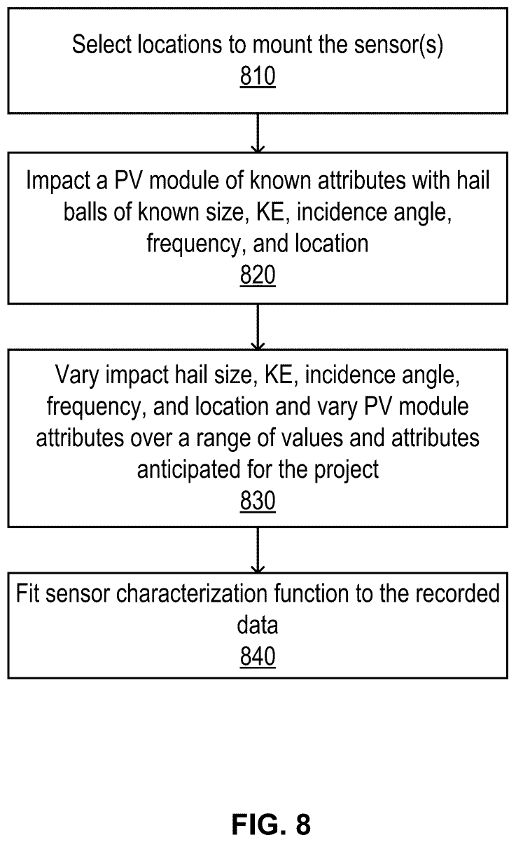

FIG. 8 is a flowchart illustrating a method for training a model to characterize hailstorms across a PV power plant. At step 810, locations of a PV module are selected to mount the sensor(s). Sensor location as installed in the field varies between embodiments. However, the sensor location in each embodiment does correspond to the location of sensors employed to generate training data for the associated model.

The trained model is based on a training data set with matching sensor locations because sensor readings will vary depending on their location on the panel. In one example, a PV system uses accelerometer sensors installed on a first edge of the PV module, the middle of the PV module, and a second edge opposite from the first edge. If a hail ball lands on the first edge, all three sensors will record a different response because the PV module material and structure, as well as environmental conditions around the PV module, will damp the movement across the PV module. Due to this variation, if sensor locations do not match between the trained data set and the observed PV system, the trained model will return less accurate predicted data. Thus, matching the trained data sensor location to the observed PV system's sensor location at step 810 will result in better data developed at steps 820 and 830 and subsequently a trained model that returns more accurate predicted data.

In some embodiments, a singe sensor is installed on the PV module to record data for the training process. In some embodiments, the single sensor is installed on an edge of the PV module. In other embodiments, the single sensor is installed on the center of the PV module (e.g. within the middle 50% of the panel area). In some embodiments, sensors are installed on the backside of the PV module laminate.

According to other embodiments, multiple sensors are installed across the PV module including, but not limited to, the backside, the backside center, and the edge. Using multiple sensors on a single PV module allows the training process to determine the variability of panel response as a function of both sensor placement and PV module impact location. For example, a PV module can have two sensors installed on it, one on an upper left corner and one in the middle. When a hail ball is dropped between the two sensors, both sensors will record an impact response. If the hail ball is dropped closer to the upper left corner, the upper left corner sensor will record a larger impact response than the sensor in the center. This difference can be used to identify that the hail impact location was closer to the upper left corner than to the center. In some embodiments, the disclosed technology averages the readings of the sensors and uses the average sensor result to describe the location of hail impact. In other embodiments, the disclosed technology compares sensor readings and takes the difference to determine the location of hail impact.

At step 820, the PV module with sensor(s) installed is impacted with hail balls of a known size, KE, incidence angle, frequency, and location on the panel. For example, the impact may be from a 1-inch diameter hail ball, with a KE of 4 Joules, at a 90-degree angle, impacted once, five inches to the left of the PV module center. After impacting, the sensor response is recorded. In some embodiments, the sensors used are accelerometers and their recorded data is the acceleration experienced by the sensors per unit time of the testing process. In some embodiments, the data recorded by the accelerometers subtracts the earth's gravitational pull to provide a tared acceleration record.

Additionally, attributes of the PV module are recorded including the PV module tilt or stow angle at the time of impact, the PV module glass thickness, the PV module tracking system damping, the PV module tracking system deflection, the PV module superstructure thickness, and the PV module superstructure construction. Attributes like these affect the reading made by the sensor. For example, a high PV module stow angle at the time of impact can reduce an acceleration reading from an accelerometer as compared to a PV module tracking system with a low stow angle. Once the model is in practice, it can check the attributes of the PV module it is receiving data from and develop its predicted data based on the training data set with the same or similar attributes.

At step 830, other combinations of hail ball impacts are made according to a design of experiments that varies hail size, KE, incidence angle, frequency, location, and PV module attributes over a range of values and attributes that are anticipated for a relevant project. The combinations in step 830 provides the model with an extensive training data set. Such a data set improves the accuracy of a model's predicted data by giving the model more data to compare observations to. For example, a training data set that only recorded a single impact between two sensors is unlikely to give an accurate location of an observed impact that happened outside the two sensors on a PV module. Whereas a training data set that has recorded impacts across the entire PV module is likely to have seen a data entry similar to the observed impact. A training data set with data similar to observed impacts allows the trained model to predict the qualities of the observed impact more accurately.

Finally, at step 840, a trained model is formed by fitting a characterization function to the training data set. The characterization function is the formula used by the trained model to determine predicted data based on observed data. In the disclosed technology, the characterization function takes a variety of forms and support a variety of data dimensionalities. In some embodiments, the characterization function is a line of best fit generated for two-dimensional training data. For example, the training data set may only record the size of hail and the corresponding KE experienced by the sensor. As such, the characterization function can be a line of best fit used to determine a size of hail based on an observed KE from a sensor. In other embodiments, the characterization function is an advanced model to interpret high-order training data. For example, the training data set may comprise hundreds of dimensions including hail size, KE, incidence angle, frequency, location, and multiple PV module attributes. As such, the characterization function can be an advanced model like a Hidden Markov Model, which predicts the hail size, incidence angle, and location of the hail impact based on the sensed KE and the known PV module attributes.

In the disclosed technology, errors and noise are considered in the training process. In some embodiments, error can occur when identifying the location of a hail strike. For example, if two sensors are placed on a PV module on the same axis, the data record for a hail ball that falls above said axis but directly in between the two sensors may look the exact same as the data record for a hail ball that falls below the axis directly in between the two sensors. As another example, the sampling rate of the sensors could be too slow to identify the location of each unique hail strike. If the PV module's sensors only sampled every second, but hail impacted the PV module three times per second, the sensor data may only be able to identify the largest hail ball within that second.

To respond to potential error and noise, some embodiments train the model with heuristics. In some embodiments, to address hail falling faster than the sampling rate, a model trained to return the location and KE of individual hail strikes will return the location of the largest KE experienced by the PV module in each sample. In some embodiments, to address error with sensors on the same axis, a model trained to return the location of a hail strike on a PV module will return a distance of the hail strike from the sensor.

In some embodiments, the model will respond to error and noise by returning data with less resolution. For example, if the model is trained to return a frequency of hail strikes on a PV module, but the hail is falling faster than the sensor sampling rate, the model can return the strike frequency as “high frequency.” In another example, a small ball of hail (e.g. a BB sized hail ball) may only create vibrations in a small range around its impact location, whereas a large ball of hail (e.g. a golf ball sized hail ball) may create vibrations in a large range around its impact location. The trained model may return low resolution data like “large hail size” and “small hail size” based on the range of vibration created by an impact. Additionally, the vibration signal created by a small ball of hail may be distinct from a vibration signal created by a larger hail ball regardless of impact location and signal attenuation. As such, in another example, where the data observed by the trained model is insufficient to identify exact hail size, the trained model can return low resolution categories for hail size like “large hail” based on distinctions in hail impact vibration signals. In another example, if the model is trained to return a hail size, but the sensor layout is not sufficient to determine exact hail size and location, the model can return the hail size as “golf ball size” or other basic descriptions like “one-inch diameter.” The model can also return the impact location as “upper left quadrant” or other similar broad descriptions.

Such low-resolution data, and ranges of resolution thereof, from the model can be applied to any output of the model as required by the observed data. In some embodiments, observed data that would create error in one trained model is automatically sent to another trained model that is better trained for the observed data. For example, a model trained on high frequency hail impacts can be sent observed data of ahigh frequency hailstorm from a model trained on discrete hail impacts alone.

Wind experienced by PV systems during hail events can induce vibrations observable by the sensors of the disclosed technology. These wind-induced vibrations create noise in the hail impact data. In some embodiments, the trained model distinguishes between hail-induced vibrations (e.g. a peak in KE corresponding to a hail ball hitting a PV module) and wind-induced vibrations (e.g. a relatively consistent oscillation corresponding to wind buffeting a PV module) to eliminate wind-induced noise. In some embodiments, the trained model only records sensor data corresponding to peaks created by hail impacts. For example, in a system with sensors sampling at 100 Hz (100 samples per second), the trained model may only record one of the 100 samples taken each second that corresponds with the peak KE experience by the PV module (e.g. the moment hail impacted the PV module). In other embodiments, the trained model only records sensor data above a threshold of which wind during the hail event could not create.

Based on the variety of potential PV module attributes, the model training process of the disclosed technology may be panel specific. For example, small PV modules may respond to similar hail impacts much differently than large PV modules based on factors like their weight or support structure connection point. As another example, a PV module with a glass thickness of 2 mm may break upon an impact of a 1-inch diameter hail ball, whereas a PV module with a glass thickness of 3.2 mm may not break. In some embodiments, the model training process can use data from PV module manufacturer certification processes as data to train a model and develop the characterization function.

In some embodiments, the model is trained to recognize types of PV modules that respond to hail events similarly and to apply a common characterization function to observations from those PV module types. For example, some large solar projects are built in stages over an extended period of time. Panel supply issues can force the large projects to use two or more panel types to complete construction. However, if each panel type used responds similarly to hail events (e.g. each panel type is the same size and material), the disclosed technology can apply a single trained model to determine the qualities of a hail event experienced by the entire project. In the case of a solar project with two or more types of PV modules that do not respond similarly to hail events, some embodiments of the disclosed technology develop a distinct trained model for each PV module type and apply it to the observed data from each PV module type to determine the qualities of a hail event experienced by the entire project.

In some embodiments, the model training process of FIG. 8 occurs after a hail event occurs. In such embodiments, the model is trained on the PV module types of the damaged PV site. Then, the trained model is fed the saved data from the PV site sensors to predict the qualities of the hailstorm experienced by said PV site.

The disclosed model training of FIG. 8 described above is specific to training a model to identify qualities of a hailstorm experienced by a PV system. For example, the disclosed method would not apply to identifying qualities of a hailstorm experienced by a residential roof. At step 810, many roofs do not have space to include the sensors, making the sensor location selection much different than in the disclosed technology. At step 820 and 830, the data recorded for impacts on a PV system are distinct from what a roof would experience. For example, roofs comprise many different materials from PV modules including, ceramic, asphalt, slate, or other composites. These materials all respond to hail impacts differently than PV modules. Additionally, many roof styles do not move or carry vibrations well in response to a hail impact. As such, many of the sensors described in the disclosed technology would be ineffective in recording the impacts experienced by the roof. Further, even for the sensors that could record the impacts experienced by the roof, the data recorded in steps 820 and 830 would vary significantly from PV module to roof and from roof to roof. Thus, at step 840, the resulting characterization function for a PV system would not be applicable to a residential roof.

In some embodiments, the trained model can determine the qualities of a hailstorm experienced by a PV system which can then be used to estimate the qualities of the hailstorm experienced by buildings and property nearby. For example, a monitored PV system on top of a parking garage can characterize the hailstorm experienced by the PV system and provide property owners and insurers of buildings nearby (e.g. within a 10-block radius of the parking garage) an estimate of the qualities of the hailstorm experienced by those buildings.

Data collected by the sensors mounted on the PV modules and other sensors monitoring the PV power site can also be used to predict the optimal sensor placement. For example, the most accurate sensor data may come from sensors installed on the backside, middle 50% area of the PV module. According to some embodiments, after training the model under a distribution of hail sizes, the trained model analyzes the training data to identify the ideal number and placement of sensors per panel, the ideal sample rate for each sensor, the ideal number of measured panels per array, and any filtering appropriate to remove unnecessary noise from the data. For example, the training data may show that the PV module structure damps the vibrations too much for a sensor placed near the frame of the structure to return valuable data. Thus, the trained model may determine that no sensor should be placed within a minimum distance of the frame.

In another example, the trained model may find that the PV system takes a minimum time to absorb an impact (e.g. one second). Based on this time to absorb, in some embodiments, the model determines an optimal technique for recording the data to reduce noise. In the disclosed technology, techniques for recording data include recording all samples of a given sample period, recording only the peak value within a given sample period (e.g. only peak acceleration every second), and recording an RMS average for a given sample period. For example, the model may determine, in the case of a 100 Hz sample rate for the sensors, that only the peak KE measurement each second should be recorded. Such a determination may avoid falsely categorizing residual vibration from a first hail impact as a second hail impact. In other embodiments, based on the time to absorb a hail impact, the model identifies an optimal sampling rate for the sensors. For example, the model may determine that a sensor sample rate of 100 Hz gives sufficient detail to identify hail impacts experienced by the PV module.

Based on the training data impacts, the trained model may also identify an ideal sensor reading to act as a trigger for a wake-up function. For example, the training data may show that some hail impacts have a very small KE and thus the wake-up function should trigger at a low KE value (e.g. a small tap from a person). Additionally, based on the training data, the trained model can identify how many sensors per panel will return the most accurate hailstorm qualities. For example, the trained model may identify that errors occur on a panel with a single sensor when attempting to identify the location of the hail impact. The trained model may also identify that additional sensors on a PV module become redundant after five sensors are installed. Further, the trained model can identify how many panels within a PV system should be monitored to give ta sufficiently accurate data about the hailstorm experienced by a PV array.

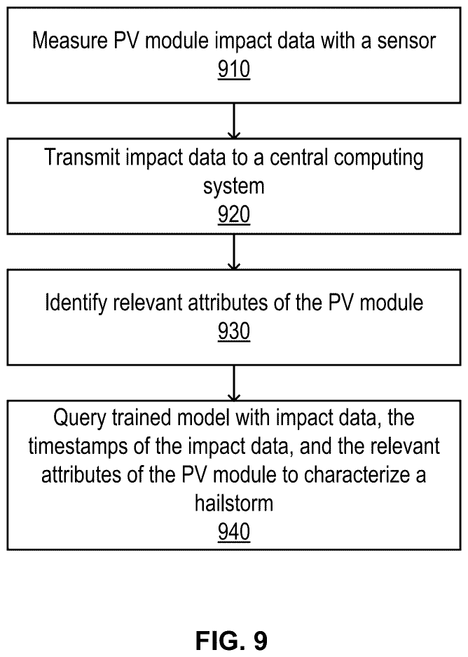

FIG. 9 is a flowchart illustrating a method for determining hail impacts using a sensor. At step 910, impacts experienced by the PV module are measured by a sensor. Specifically, the sensor measures the vibratory response of the PV module as a result of the impact at the location of the PV module where the sensor is installed.

The exact vibratory response will depend on many factors. The vibratory response will vary based on how much KE the hail ball exerts on the PV module. For example, a high KE impact will vibrate the panel more than a low KE impact. The vibratory response will also depend on where the hail ball hit the PV module. For example, a hail ball that lands at the edge of the PV module likely will not cause as much panel motion as a hail ball that lands on the center of the PV module. Additionally, for a hail ball landing at the edge, the vibratory response may be sharp in that there is a sudden impact that is then quickly dissipated through the PV module frame. Whereas, in the case of a hail ball landing on the center of the PV module, the vibratory response may be elongated as the PV module oscillates and dissipates the impact energy through said oscillation and the panel.

The vibratory response, as measured by the sensor, will depend on the impact location relative to the sensor as well. Vibrations from a hail impact that lands far away from a sensor are likely attenuated by the time the sensor experiences the vibrations. Thus, a weak vibration reading may signal that a large hail ball landed on the opposite side of the PV module from the sensor or that a small hail ball landed nearby the sensor. The vibratory response will also vary based on the frequency of hail impacts. For example, a PV module hit with one hail ball may vibrate much less than a PV module hit with two hail balls. Further, the PV module material type can affect the vibratory response recorded by the sensor because some materials translate vibrations across a PV module structure more than others.

The sensor sampling time also affects what vibratory response the sensor records. For example, if the sensor samples at the time of a hail impact, the motion detected by the sensor will be more than the damped motion experienced by the sensor if the sensor sampled the same hail impact a half second later. The interaction of vibrations caused by multiple hail impacts will also affect the vibratory response recorded by the sensor. For example, the vibration oscillations caused by a first hail ball may be disrupted by oscillations caused by a second hail ball.

At step 920 the sensor device transmits the impact data, as affected by factors including those described above, to a central computing system. At step 930, the central computing system identifies relevant attributes of the PV module from pre-recorded data and data from secondary sensors. The PV module attribute data pertains to characteristics of the power plant including, but not limited to, sensor location on the PV module, PV module tilt angle during hail impacts, PV module stow angle, PV module glass thickness, PV module tracking system damping, PV module tracking system deflection, PV module structure thickness, PV module superstructure construction, PV power plant site topography, and PV site wind conditions. In some embodiments, this attribute data is be pre-recorded on the central computing system. For example, upon installation, the sensor locations on the PV modules may be entered into the central computing system. In some embodiments, the central computing system reads data from secondary sensors installed on the site to determine the relevant PV module attributes. For example, the central computing system may check for the PV module tilt angle at the moment of the hail impact based on tilt angle sensors installed on the tracking system. Additionally, PV sites may have anemometers or other wind sensing devices that collect data to describe the wind direction and speed. In the disclosed technology, the central computing system can collect wind data from said wind sensing devices. Data like PV module tilt angle and wind direction and speed can help the trained model determine qualities of the hailstorm experienced by a PV site like hail incidence angle.

At step 940, the central computing system queries a trained model with the impact data, the timestamps of the impact data, and the PV module attribute data to determine the qualities of a hailstorm experienced by the PV module. In some embodiments, the trained model assumes that the hail impact data received from the central computing system occurred at a specific location known from the training process to generate the highest sensor response for a given KE and incidence angle. Making this assumption assigns the minimum hail ball KE to the strike because an impact at another location would require higher KE to generate the same response at the sensor. When multiple sensors are installed on a single panel, further determination of hail ball KE is possible by replicating this process for each sensor, resulting in higher minimum KE estimates. Statistical methods can be used to estimate minimum and maximum bounds for a given hail impact. Further refinement of KE estimates is possible by comparing sensors on other modules within a given site to each other to determine the average and maximum hail ball sizes occurring on a site at any given time.

In some embodiments, the trained model returns a hail map describing the qualities of a hailstorm experienced by a PV module. In other embodiments, the trained model returns a hail map describing the qualities of a hailstorm experienced by a PV site. Said qualities include, but are not limited to, hail size, hail impact force, hail impact KE, hail location, hail frequency, hail incidence angle, hailstorm duration, location of PV module failure, time of PV module failure, and PV module attribute data before, during, and after the hailstorm. In some embodiments, the hail map is a visual representation of the hailstorm qualities. For example, the trained model can generate a histogram showing the total KE of all hail impacts or the highest KE of a single impact.

In some embodiments, the trained model returns the hailstorm qualities, and the central computing system sends those qualities to a display device with instructions to display a map of the hailstorm and its qualities. In some embodiments, the display shows a graphical representation of the hailstorm qualities over time. For example, the graphical representation can show an animation of the path of the hailstorm across a PV site and identify where and when the largest hail impacted the PV site. The graphical representation can also indicate the PV module attribute data throughout the hailstorm. In some embodiments, the graphical representation identifies which PV modules failed.

In some embodiments, a user interacts with the display of the hailstorm map to view specific hailstorm qualities of interest. For example, the user may filter for a display of hail frequency or for a display of hail incidence angle. In some embodiments, a user can select a time within the hailstorm to view and the hail map will identify all qualities of the hailstorm experienced by a PV module or the PV site at that time. In some embodiments, the hail map identifies regions of the PV site and the associated hailstorm qualities of those regions. Said regions can correspond to regional mesh networks or to other aspects of the PV site. In some embodiments, a user can filter the display to show hailstorm qualities of one or more regions. For example, the map can show a region hail size, a region hail impact force, a region hail impact KE, a region hail impact frequency, a region hail impact incidence angle, a region hailstorm duration, and a region time of PV module failure.

In some embodiments, the trained model can indicate that a large hail event has significantly damaged a section of a PV system. In some embodiments, the hail map generated by the trained model identifies a predicted damage cost across a PV site or a PV module. In other embodiments, the trained model can use the data collected by the sensors to predict when maintenance services are needed for the PV system. For example, the collected data may indicate that a section of the PV system needs maintenance when that section experienced greater vibrations than other sections of the PV system while under the same hail conditions.

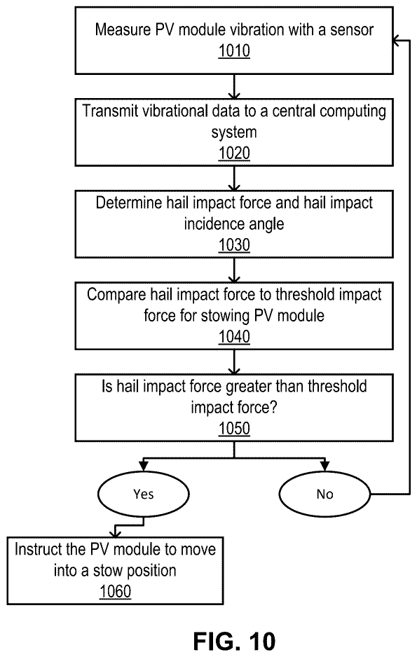

FIG. 10 is a flowchart illustrating a method for determining when to stow PV modules. At step 1010, PV module vibration is measured with a sensor. At step 1020, vibrational data is transmitted to a central computing system. At step 1030, the hail impact force experienced by the PV module and hail impact incidence angle to the PV module is determined. At step 1040, the computing system compares the hail impact force to a threshold impact force for stowing the PV module. At step 1050, the computing system determines if the PV module impact force is greater than the threshold impact force. If the PV module impact force is not greater than the threshold impact force then the process repeats when new vibrational data is received. At step 1060, if the PV module impact force is greater than the threshold impact force then the computing system instructs the PV module to move into a stow position that adjusts the determined hail impact incidence angle to mitigate PV module damage. In one embodiment, the stow position is a high tilt position in which the PV module is tilted to the maximum angle possible relative to the ground.

In some embodiments, the tracking system sends a signal to individual actuators for individual rows of PV modules and/or individual actuators for individual PV modules to adjust the corresponding PV module tilt. The ability to tilt panels and rows individually allows the disclosed technology to maximize damage reduction during a hailstorm. For example, some hailstorms can have differences in the direction the hail is dropping over a large-scale PV power plant. As such, a PV module tilt angle that reduces the most damage on one side of the large-scale PV power plant may not be the best angle to reduce the most damage on another side. Additionally, PV power plant sites can have varying topography, which can alter the exposure individual PV modules in the site have to hailstorms. The ability to tilt panels and rows individually, therefore, allows the disclosed technology to respond to hailstorm and topography variation across PV power plant sites.

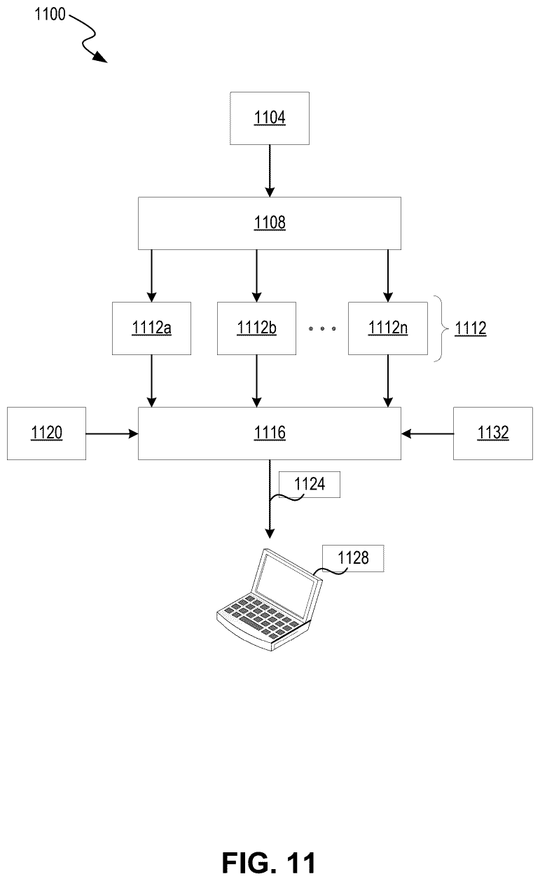

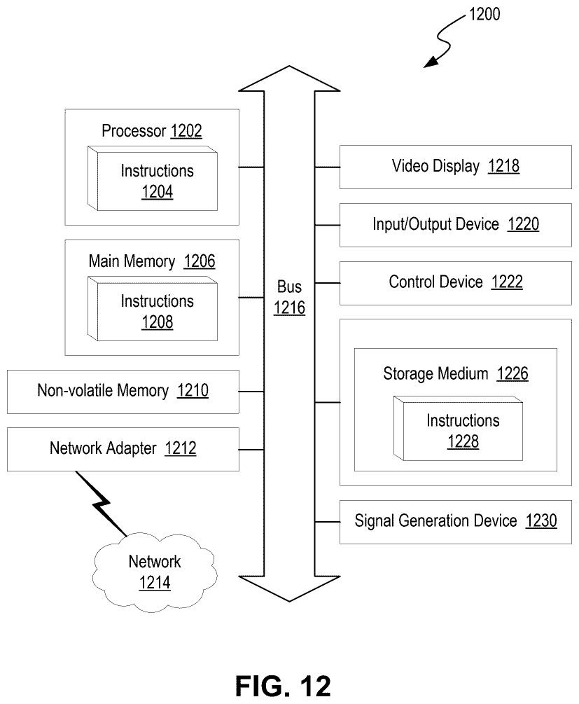

FIG. 11 is a block diagram illustrating an example ML system 1100, in accordance with one or more embodiments. The ML system 1100 is implemented using components of the example computer system 1200 illustrated and described in more detail with reference to FIG. 12. For example, portions of the ML system 1100 are implemented on the apparatus 100 illustrated and described in more detail with reference to FIG. 1, or in the trained model 710 illustrated and described in more detail with reference to FIG. 7. Likewise, different embodiments of the ML system 1100 include different and/or additional components and are connected in different ways. The ML system 1100 is sometimes referred to as a ML module.

The ML system 1100 includes a feature extraction module 1108 implemented using components of the example computer system 1200 illustrated and described in more detail with reference to FIG. 12. In some embodiments, the feature extraction module 1108 extracts a feature vector 1112 from input data 1104. For example, the input data 1104 includes location parameters measured by device implemented in accordance with the architecture 100 illustrated and described in more detail with reference to FIG. 1. The feature vector 1112 includes features 1112a, 1112b, . . . , 1112n. The feature extraction module 1108 reduces the redundancy in the input data 1104, for example, repetitive data values, to transform the input data 1104 into the reduced set of features 1112, for example, features 1112a, 1112b, . . . , 1112n. The feature vector 1112 contains the relevant information from the input data 1104, such that events or data value thresholds of interest are identified by the ML model 1116 by using a reduced representation. In some example embodiments, the following dimensionality reduction techniques are used by the feature extraction module 1108: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 1116 performs deep learning (also known as deep structured learning or hierarchical learning) directly on the input data 1104 to learn data representations, as opposed to using task-specific algorithms. In deep learning, no explicit feature extraction is performed; the features 1112 are implicitly extracted by the ML system 1100. For example, the ML model 1116 uses a cascade of multiple layers of nonlinear processing units for implicit feature extraction and transformation. Each successive layer uses the output from the previous layer as input. The ML model 1116 thus learns in supervised (e.g., classification) and/or unsupervised (e.g., pattern analysis) modes. The ML model 1116 learns multiple levels of representations that correspond to different levels of abstraction, wherein the different levels form a hierarchy of concepts. The multiple levels of representation configure the ML model 1116 to differentiate features of interest from background features.

In alternative example embodiments, the ML model 1116, for example, in the form of a CNN generates the output 1124, without the need for feature extraction, directly from the input data 1104. The output 1124 is provided to the computer device 1128. The computer device 1128 is a server, computer, tablet, smartphone, etc., implemented using components of the example computer system 1200 illustrated and described in more detail with reference to FIG. 12. In some embodiments, the steps performed by the ML system 1100 are stored in memory on the computer device 1128 for execution. In other embodiments, the output 1124 is displayed on an electronic display.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field is approximated mathematically by a convolution operation. CNNs are based on biological processes and are variations of multilayer perceptrons designed to use minimal amounts of preprocessing.

In embodiments, the ML model 1116 is a CNN that includes both convolutional layers and max pooling layers. For example, the architecture of the ML model 1116 is “fully convolutional,” which means that variable sized sensor data vectors are fed into it. For convolutional layers, the ML model 1116 specifies a kernel size, a stride of the convolution, and an amount of zero padding applied to the input of that layer. For the pooling layers, the model 1116 specifies the kernel size and stride of the pooling.

In some embodiments, the ML system 1100 trains the ML model 1116, based on the training data 1120, to correlate the feature vector 1112 to expected outputs in the training data 1120. As part of the training of the ML model 1116, the ML system 1100 forms a training set of features and training labels by identifying a positive training set of features that have been determined to have a desired property in question, and, in some embodiments, forms a negative training set of features that lack the property in question.

The ML system 1100 applies ML techniques to train the ML model 1116, that when applied to the feature vector 1112, outputs indications of whether the feature vector 1112 has an associated desired property or properties, such as a probability that the feature vector 1112 has a particular Boolean property, or an estimated value of a scalar property. In embodiments, the ML system 1100 further applies dimensionality reduction (e.g., via linear discriminant analysis (LDA), PCA, or the like) to reduce the amount of data in the feature vector 1112 to a smaller, more representative set of data.

In embodiments, the ML system 1100 uses supervised ML to train the ML model 1116, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 1132 is formed of additional features, other than those in the training data 1120, which have already been determined to have or to lack the property in question. The ML system 1100 applies the trained ML model 1116 to the features of the validation set 1132 to quantify the accuracy of the ML model 1116. Common metrics applied in accuracy measurement include Precision and Recall, where Precision refers to a number of results the ML model 1116 correctly predicted out of the total it predicted, and Recall is a number of results the ML model 1116 correctly predicted out of the total number of features that had the desired property in question. In some embodiments, the ML system 1100 iteratively re-trains the ML model 1116 until the occurrence of a stopping condition, such as the accuracy measurement indication that the ML model 1116 is sufficiently accurate, or a number of training rounds having taken place. In embodiments, the validation set 1132 includes data corresponding to confirmed locations, dates, times, activities, or combinations thereof, allowing the detected values to be validated using the validation set 1132. The validation set 1132 is generated based on the analysis to be performed.

FIG. 12 is a block diagram illustrating an example computer system 1200, in accordance with one or more embodiments. In some embodiments, components of the example computer system 1200 are used to implement the software platforms described herein. At least some operations described herein can be implemented on the computer system 1200.

In some embodiments, the computer system 1200 includes one or more central processing units (“processors”) 1202, main memory 1206, non-volatile memory 1210, network adapters 1212 (e.g., network interface), video displays 1218, input/output devices 1220, control devices 1222 (e.g., keyboard and pointing devices), drive units 1224 including a storage medium 1226, and a signal generation device 1220 that are communicatively connected to a bus 1216. The bus 1216 is illustrated as an abstraction that represents one or more physical buses and/or point-to-point connections that are connected by appropriate bridges, adapters, or controllers. The bus 1216, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1694 bus (also referred to as “Firewire”).

In some embodiments, the computer system 1200 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1200.

While the main memory 1206, non-volatile memory 1210, and storage medium 1226 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1228. The term “machine-readable medium” and “storage medium” shall also be taken to include any medium that is capable of storing, encoding, or carrying a set of instructions for execution by the computer system 1200. In some embodiments, the non-volatile memory 1210 or the storage medium 1226 is a non-transitory, computer-readable storage medium storing computer instructions, which is executable by one or more “processors” 1202 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1204, 1208, 1228) set at various times in various memory and storage devices in a computer device. When read and executed by one or more processors 1202, the instruction(s) cause the computer system 1200 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1210, floppy and other removable disks, hard disk drives, optical discs (e.g., compact disc read-only memory (CD-ROMS), digital versatile discs (DVDs)), and transmission-type media such as digital and analog communication links.

The network adapter 1212 enables the computer system 1200 to mediate data in a network 1214 with an entity that is external to the computer system 1200 through any communication protocol supported by the computer system 1200 and the external entity. The network adapter 1212 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1212 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1100 illustrated and described in more detail with reference to FIG. 11.

1. A system for mapping a hailstorm experienced by a photovoltaic (PV) array of a solar tracker system within a solar power plant comprising:
a sensor mounted on a first PV module of the solar power plant, the sensor configured to directly measure vibrational data experienced by the first PV module through the first PV module as corresponding to weather effects;
a second PV module of the solar power plant, the second PV module having a solar tracking path that includes a first tilt angle, wherein the second PV module is non-adjacent to the first PV module within the solar power plant; and
a central computing system communicatively coupled to the sensor configured to:
characterize a hailstorm through which the vibrational data was experienced, said characterization based on querying a trained hail model with attribute data of the first PV module, the vibrational data, and timestamps of the vibrational data;
generate a hailstorm map relative to the PV array; and
cause, based on the characterization of the hailstorm, a real-time reconfiguration of the second PV module positioned non-adjacent to the first PV module within the solar power plant that moves the second PV module from the first tilt angle of the solar tracking path to a second tilt angle that corresponds to a hail stow position, wherein the hail stow position reduces a surface area of the second PV module that is oriented to the sky.

2. The system of claim 1, wherein the central computing system is communicatively coupled to the sensor via a data transmission device, the data transmission device transmitting the vibrational data as measured by the sensor, and wherein the data transmission device is a wireless transceiver configured to integrate into a mesh network of data transmission devices communicatively coupled with sensors.

3. The system of claim 1, wherein the attribute data of the first PV module includes one or more of:
first PV module tilt angle during hail impacts;
first PV module stow angle;
first PV module glass thickness;
tracking system damping;
tracking system deflection;
first PV module superstructure thickness; and
first PV module superstructure construction.

4. The system of claim 1, wherein characterization of the hailstorm comprises identifying one or more of:
hail size;
hail impact force;
hail impact kinetic energy;
hail impact location;
hail impact frequency;
hail impact incidence angle;
hailstorm duration;
location of PV module failure; and
time of PV module failure.

5. The system of claim 1, wherein the PV array is of a single-axis, flexible tracker system configuration.

6. The system of claim 1, wherein a plurality of sensors is positioned along a plurality of PV modules of the solar power plant, wherein the central computing system identifies a plurality of regions of the PV array, each of the plurality of regions corresponding to one or more adjacent sensors of the plurality of sensors, wherein the central computing system characterizes the hailstorm through which the vibrational data was experienced for each of the plurality of regions, and wherein the central computing system generates a site-wide hailstorm map across the PV array.

7. The system of claim 1, wherein said mount on the first PV module of the solar power plant comprises a physical attachment to any of:
a laminate of the first PV module;
a frame of the first PV module; or
a support structure of the first PV module.

8. A method for measuring photovoltaic (PV) panel impacts across a PV array of a solar tracker system within a solar power plant, the method comprising:
collecting, via a sensor mounted on a first PV module of the solar power plant, data indicative of an impact experienced by the first PV module, wherein the sensor is communicatively coupled to a central computing system, and wherein the sensor is configured to directly measure the data through the first PV module;
querying, using the central computing system, a trained hail model with the data, timestamps of the data, and attribute data of the first PV module;
characterizing, by the central computing system, a hailstorm through which the data was experienced;
generating, by the central computing system, a hailstorm map relative to the PV array; and
causing, by the central computing system and based on the characterization of the hailstorm, a real-time re-configuration of a second PV module of the solar power plant such that the second PV module moves from a first tilt angle of a solar tracking path of the second PV module to a second tilt angle that corresponds to a hail stow position, wherein the hail stow position reduces a surface area of the second PV module that is oriented to the sky, and wherein the second PV module is positioned non-adjacent to the first PV module within the solar power plant.

9. The method of claim 8, wherein the sensor is communicatively coupled to the central computing system using a communication device that transmits the data to the central computing system, and wherein the communication device is a wireless transceiver configured to integrate into a mesh network of data transmission devices communicatively coupled with sensors.

10. The method of claim 8, wherein the attribute data of the first PV module includes one or more of:
first PV module tilt angle during hail impacts;
first PV module stow angle;
first PV module glass thickness;
tracking system damping;
tracking system deflection;
first PV module superstructure thickness; and
first PV module superstructure construction.

11. The method of claim 8, wherein characterization of the hailstorm comprises identifying one or more of:
hail size;
hail impact force;
hail impact kinetic energy;
hail impact location;
hail impact frequency;
hail impact incidence angle;
hailstorm duration;
location of PV module failure; and
time of PV module failure.

12. The method of claim 8, wherein the PV array is of a single-axis, flexible tracker system configuration.

13. The method of claim 8, wherein a plurality of sensors is positioned along a plurality of PV modules of the solar power plant, wherein the central computing system identifies a plurality of regions of the PV array, each of the plurality of regions corresponding to one or more adjacent sensors of the plurality of sensors, wherein the central computing system characterizes the hailstorm through which the data was experienced for each of the plurality of regions, and wherein the central computing system generates a site-wide hailstorm map across the PV array.

14. The method of claim 9, further comprising a power supply, the power supply configured to power the sensor and the communication device.

15. A solar power plant data system for mapping a hailstorm experienced by a photovoltaic (PV) array of a solar tracker system comprising:
a plurality of sensors mounted on a plurality of PV modules of a solar power plant, the plurality of sensors configured to directly measure vibrational data experienced by the plurality of PV modules through the plurality of PV modules in multiple locations within the solar power plant, wherein the plurality of PV modules each have a solar tracking path; and
a central computing system communicatively coupled to the plurality of sensors configured to:
characterize a hailstorm through which the vibrational data was experienced, said characterization based on querying a trained hail model with PV module attribute data, the vibrational data, and timestamps of the vibrational data;
generate a site-wide hailstorm map relative to the PV array; and
cause, based on the characterization of the hailstorm, a real-time reconfiguration of one or more PV modules of the plurality of PV modules such that the one or more PV modules move from a first tilt angle along the solar tracking path to a second tilt angle that corresponds to a hail stow position, wherein the hail stow position reduces a surface area of each of the one or more PV modules that is oriented to the sky.

16. The system of claim 15, wherein the plurality of sensors are communicatively coupled to the central computing system via a data transmission device, the data transmission device transmitting the vibrational data as measured by the plurality of sensors, and wherein the data transmission device is a wireless transceiver configured to integrate into a mesh network of data transmission devices communicatively coupled with sensors.

17. The system of claim 15, wherein the PV module attribute data includes one or more of:
PV module tilt angle during hail impacts;
PV module stow angle;
PV module glass thickness;
tracking system damping;
tracking system deflection;
PV module superstructure thickness; and
PV module superstructure construction.

18. The system of claim 15, wherein characterization of the hailstorm further comprising:
identifying a plurality of regions of the PV array, each of the plurality of regions corresponding to one or more adjacent sensors of the plurality of sensors; and
characterizing the hailstorm through which the vibrational data was experienced in each of the plurality of regions, said characterization comprises identifying one or more of: a region hail size, a region hail impact force, a region hail impact kinetic energy, a region hail impact frequency, a region hail impact incidence angle, a region hailstorm duration, and a region time of PV module failure.

19. The system of claim 15, wherein said mount on the PV modules of the solar power plant comprises a physical attachment to any of:
a laminate of the PV modules;
a frame of the PV modules; or
a support structure of the PV modules.

20. The system of claim 16, further comprising a power supply, the power supply configured to power the plurality of sensors and the data transmission device.
